(19) United States
(12) Patent Application Publication
(10) Pub. No.: US 2022/0172088 A1
(43) Pub. Date: Jun. 2, 2022

(54) MODEL SELECTION FOR DISCRETE LATENT VARIABLE MODELS

(71) Applicant: International Business Machines Corporation, Armonk, NY (US)

(72) Inventor: Hiroshi Kajino, Tokyo (JP)

(21) Appl. No.: 17/109,566

(22) Filed: Dec. 2, 2020

(51) Int. Cl. G06N 7/00; G06N 20/00

(52) U.S. Cl. CPC G06N 7/005; G06N 20/00

(57) ABSTRACT

In a method for selecting a model, a processor inputs a data stream with observable variables into a first model having a first number of states and a second model having a second number of states. A processor estimates first and second model parameters of the first model and the second model, respectively, using the observable variables. A processor estimates latent variables that associate each observable variable with one of the states. A processor calculates state-permutation-invariant differences between each time consecutive pair of latent variables. A processor calculates a first time inconsistency measure for the first model by summarizing first state-permutation-invariant differences, and calculates a second time inconsistency measure for the second model by summarizing second state-permutation-invariant differences. A processor selects a smallest time inconsistency measure between the first time inconsistency measure and the second time inconsistency measure.

### BACKGROUND

The present invention relates generally to the field of model selection in machine learning, and more particularly to automatically selecting a correct number of states for a model.

In machine learning, a model is defined as the mathematical representation of a given data set that results from the training process. An algorithm, run on the machine learning computer, finds the pattern in the given data set and trains the model, which approximates the target function and maps the inputs to the outputs from the available dataset. Selecting the correct model for the algorithm to train depends upon the type of task and the type of data set that is being used to train the model. Model types include classification models, regression models, clustering, dimensionality reductions, principal component analysis, etc. Appropriate selection of the correct model can be critical in generating an accurate mathematical representation using a suitable amount of resources.

### SUMMARY

Aspects of an embodiment of the present invention disclose a method, computer program product, and computing system for selecting a model. A processor inputs a data stream with observable variables x_{1:t} into a first model having a first number of states. Each observable variable represents a value at a time step, and the data stream increases by one observable variable after a successive time step. A processor estimates a first model parameter of the first model using the observable variables x:_{0:T}. A processor estimates first latent variables z_{0:T}(x_{0:T}) that associate each observable variable with one of the first number of states. A processor calculates first state-permutation-invariant differences Δ_{0:T} between each time consecutive pair of latent variables, zₜ(xₜ) and zₜ₊₁(xₜ₊₁). A processor calculates a first time inconsistency measure for the first model by summarizing the first state-permutation-invariant differences Δ_{0:T}. A processor inputs the data stream into a second model with a second number of states. A processor estimates a second model parameter of the second model using the observable variables x:_{0:T}. A processor estimates second latent variables z_{0:T}(x_{0:T}) that associates each observable variable with one of the second number of states. A processor calculates a second state-permutation-invariant difference Δ_{0:T}; between each time consecutive pair of latent variables, zₜ(xₜ) and zₜ₊₁(xₜ₊₁). A processor calculates a second time inconsistency measure for the second model by summarizing the state-permutation-invariant differences Δ_{0:T}. A processor determines a smallest time inconsistency measure between the first time inconsistency measure and the second time inconsistency measure. A processor selects one of the first model and the second model, based on the model corresponding to the smallest time inconsistency measure.

### BRIEF DESCRIPTION OF THE DRAWINGS

FIG. 1 is a functional block diagram illustrating a chart evaluator environment, in accordance with an embodiment of the present invention;

FIG. 2 is a flowchart depicting operational steps of a model selection program, in accordance with an embodiment of the present invention;

FIGS. 3A-3D depict graphical representations of the operational procedures taken on a data stream of observable variables 302 by the model selection program 150, in accordance with an embodiment of the present invention;

FIGS. 4A-4B depict graphical representations of the operational procedures taken on the data stream of observable variables 302 by the model selection program 150, in accordance with an embodiment of the present invention;

FIG. 5 depicts a graphical representation of time inconsistency measure for a given number of states in a model, in accordance with an embodiment of the present invention; and

FIG. 6 is a block diagram of components of the computer executing the model selection program, in accordance with an embodiment of the present invention.

### DETAILED DESCRIPTION

Existing approaches to selecting an appropriate model (e.g., Akaike information criterion (AIC), Bayesian Information Criterion (BIC), Takeuchi information criterion (TIC), widely applicable information criterion (WAIC), widely applicable Bayesian information criterion (WBIC), and minimal description length (MDL)) cannot be applied to singular models including latent variable models, especially when computation resources are limited to any degree. Furthermore, none of the existing model selection methods consider a dynamic data stream. The embodiments disclosed herein describe a model selection procedure for discrete latent variable models trained on a dynamic data stream. The model selection procedure uses a comparison of models having a different number of states.

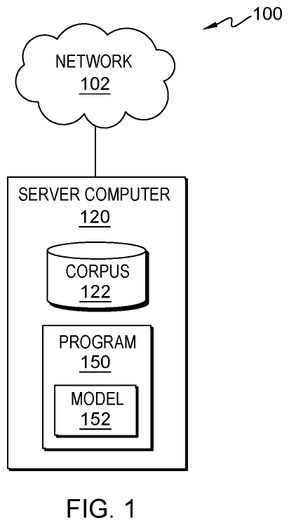

FIG. 1 depicts a functional block diagram illustrating a computational environment 100, in accordance with one embodiment of the present invention. The term “computational” as used in this specification describes a computer system that includes one or multiple, physically, distinct devices that operate together as a single computer system. FIG. 1 provides only an illustration of one implementation and does not imply any limitations regarding the environments in which different embodiments may be implemented. Many modifications to the depicted environment may be made by those skilled in the art without departing from the scope of the invention as recited by the claims.

The computational environment 100 includes a server computer 120 connected over a network 102. The network 102 can be, for example, a telecommunications network, a local area network (LAN), a wide area network (WAN), such as the Internet, or a combination of the three, and can include wired, wireless, or fiber optic connections. The network 102 can include one or more wired and/or wireless networks that are capable of receiving and transmitting data, voice, and/or video signals, including multimedia signals that include voice, data, and video information. In general, the network 102 can be any combination of connections and protocols that will support communications between the server computer 120, and other computing devices (not shown) within the computational environment 100. In various embodiments, the network 102 operates locally via wired, wireless, or optical connections and can be any combination of connections and protocols (e.g., personal area network (PAN), near field communication (NFC), laser, infrared, ultrasonic, etc.).

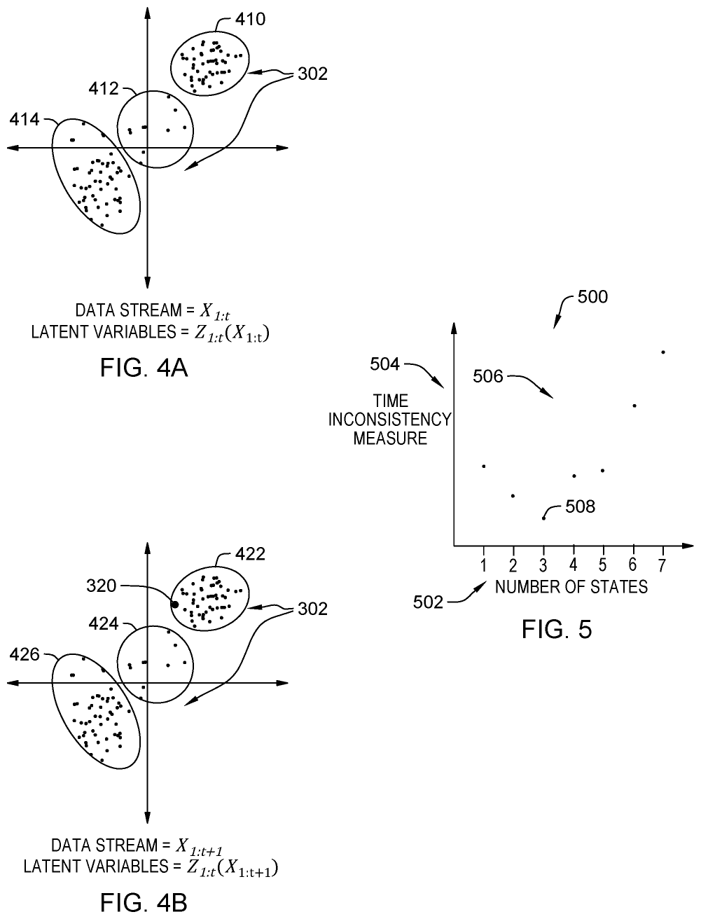

The server computer 120 can be a standalone computing device, a management server, a web server, a mobile computing device, or any other electronic device or computing system capable of receiving, sending, and processing data. In other embodiments, the server computer 120 can represent a server computing system utilizing multiple computers as a server system, such as in a cloud computing environment. In another embodiment, the server computer 120 can be a laptop computer, a tablet computer, a netbook computer, a personal computer (PC), a desktop computer, a personal digital assistant (PDA), a smart phone, or any programmable electronic device capable of communicating with other computing devices (not shown) within the computational environment 100 via the network 102. In another embodiment, the server computer 120 represents a computing system utilizing clustered computers and components (e.g., database server computers, application server computers, etc.) that act as a single pool of seamless resources when accessed within the computational environment 100. In the depicted embodiment, the server computer 120 includes a corpus 122 and a model selection program 150. In other embodiments, the server computer 120 may contain other applications, databases, programs, etc. which have not been depicted in the computational environment 100. The server computer 120 may include internal and external hardware components, as depicted and described in further detail with respect to FIG. 4.

The corpus 122 is a repository for data used by the model selection program 150. In the depicted embodiment, the corpus 122 resides on the server computer 120. In another embodiment, the corpus 122 may reside elsewhere within the computational environment 100 provided the model selection program 150 has access to the corpus 122. The corpus 122 can be implemented with any type of storage device capable of storing data and configuration files that can be accessed and utilized by the model selection program 150, such as a database server, a hard disk drive, or a flash memory. In an embodiment, the corpus 122 stores a data stream used by the model selection program 150, such as one or more examples, sets of training data, data structures, and/or variables used to fit the parameters of a specified model. The data stream may include pairs of input vectors with associated output vectors. In an embodiment, the corpus 122 may contain one or more sets of one or more instances of unclassified or classified (e.g., labelled) data, hereinafter referred to as training statements. In another embodiment, the training data contains an array of training statements organized in a labelled data stream. In an embodiment, each data stream includes a label and an associated array or set of training statements which can be utilized to train one or more models. In an embodiment, the corpus 122 contains unprocessed training data. In an alternative embodiment, the corpus 122 contains natural language processed (NLP) (e.g., section filtering, sentence splitting, sentence tokenizer, part of speech (POS) tagging, tf-idf, etc.) feature sets. In a further embodiment, the corpus 122 contains vectorized data streams, associated training statements, and labels.

The model 152 is representative of one or more machine learning models. In an embodiment, the model 152 is comprised of any combination of machine learning models, techniques, and algorithms (e.g., Gaussian mixture models, hidden Markov models, decision trees, Naive Bayes classification, support vector machines for classification problems, random forest for classification and regression, linear regression, least squares regression, logistic regression). The model 152 has model parameters, which are learned from data by maximum likelihood estimation or Bayesian estimation, as well as hyperparameters including the number of states, which is difficult to learn from data using the aforementioned standard estimation tools.

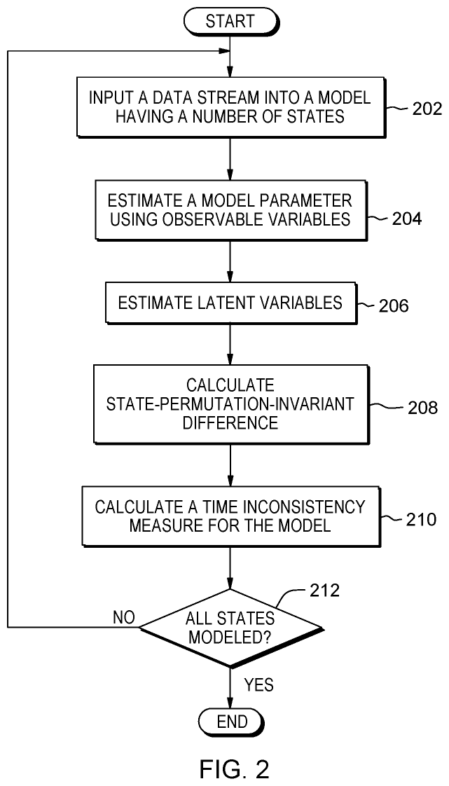

The model selection program 150 is a program for selecting a model to be used on a dynamic data stream. In the depicted embodiment, the model selection program 150 is a standalone software program. In another embodiment, the functionality of the model selection program 150, or any combination programs thereof, may be integrated into a single software program. In some embodiments, the model selection program 150 may be located on separate computing devices (not depicted) but can still communicate over the network 102. In various embodiments, client versions of the model selection program 150 may reside on any other computing device (not depicted) within the computational environment 100. The model selection program 150 is depicted and described in further detail with respect to FIG. 2.

FIG. 2 depicts operational procedures of the model selection program 150 of FIG. 1, in accordance with an embodiment of the present invention. The model selection program 150 may go through several cycles of the method using a different number of states for the model. The model selection program 150 aims to find the best model with the best number of states to use for continued modeling. The model selection program 150 begins by inputting a data stream (i.e., x₁, x₂, . . . x_{T}=x_{1:T}) into a model (block 202). The data stream may include any type of observable variable, and the measurements recorded as the observable variables may be taken as a time-dependent data stream. That is, each observable variable may represent a vector at a time step. Furthermore, the data stream may be periodically input into the model over time, meaning that the data stream increases by one observable variable after a successive time step (i.e., data stream is x_{1:T+1}).

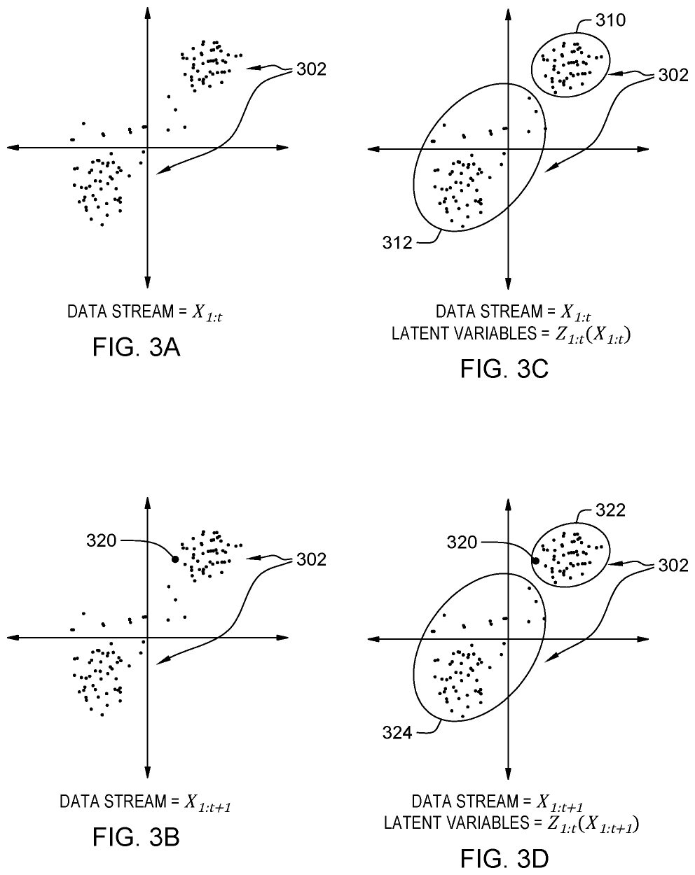

FIGS. 3A-3D depict graphical representations of the operational procedures taken on a data stream of observable variables 302 by the model selection program 150, in accordance with an embodiment of the present invention. FIGS. 3A and 3C represent operational procedures at a first time step “T”, while FIGS. 3B and 3D represent operational procedures at a second time step “T+1” with an additional observable variable 320. The representations depicted in FIGS. 3A-3D show the observable variables 302 in two dimensions (i.e., x value, y value), but observable variables, in certain embodiments of the invention, may include vectors of dozens or hundreds of dimensions.

The model into which the model selection program 150 inputs the data stream is a model having a number of states. In general, the number of states used by a given model type can be one of the most influential selections for accurately modeling the data stream. In the disclosed embodiments, the number of states may be selected by a user programming the model selection program 150, or the model selection program 150 may select the first number of states to try using a default initial states number.

In the representation of FIGS. 3C and 3D, for example, the number of states is two (i.e., state one 310, state two 312 in FIG. 3C, and state one 322 and state two 324 in FIG. 3D). The data stream may be input into models with any number of states, typically tracked by the number K. K may be any integer, for example, an integer between 1 and 10, or 1 and 100.

The model selection program 150 then estimates, for each time step, a model parameter using the observable variables of the data stream (block 204). In certain embodiments, the model selection program 150 tries one set of estimated model parameters and calculates a likelihood function. The likelihood function measures how likely the observable variables of the data stream occur given the current estimated model parameters. The model selection program 150 then adjusts the estimated model parameters to maximize the likelihood function. By maximizing the likelihood, the model selection program 150 estimates the best model parameters to explain the data stream. In the representation of FIG. 3B, the model parameters may be thought of as the location, size, and shape of the area covered by state one 310 and state two 312.

The model selection program 150 also estimates, for each time step, latent (i.e., hidden, unobservable) variables (block 206). The latent variables are a value (e.g., integer value, probability distribution value) that indicates a state for a corresponding observable variable. In certain embodiments, the latent variables are estimated by optimizing a posterior distribution of the latent variables given the observable variables and the model parameters. Additionally or alternatively, the model parameters and latent variables are learned simultaneously by expectation maximization algorithms known in the art.

In the time step illustrated in FIG. 3C, the latent variables include values of “1” for each of the observable variables in state one 310, and values of “2” for each of the observable variables in state two 312. In the time step illustrated in FIG. 3D, the latent variables include values of “1” for each of the observable variables in state one 322, and values of “2” for each of the observable variables in state two 324.

The model selection program 150 then calculates a state-permutation-invariant difference Δₜ for each time consecutive pair of latent variables (i.e., zₜ(xₜ) and zₜ₊₁(xₜ₊₁)) (block 208). The difference is permutation-invariant because the model selection program 150 is not constrained in labeling state one and state two from one time step to another. So, while it may be obvious to a human observer in the simplified representation in FIGS. 3A-3D which state from one time step (e.g., state one 310) corresponds to which state from a different time step (e.g., state one 322), the model selection program 150 may not apply the label to the states in this manner. Therefore, the model selection program 150 takes the latent variables included in a first state at a first time step (i.e., state one 310), and compares (e.g., subtracts) them to all states for the next succeeding time step (i.e., state one 322 and state two 324), and the latent variables included in a second state at a first time step (i.e., state two 312), and compare them to all states for the next succeeding time step (i.e., state one 322 and state two 324). The comparison with the smallest difference for all states is kept by the model selection program 150 as the state-permutation-invariant difference Δₜ. In certain embodiments, the model selection program 150 may also enforce exclusivity so that each state from a first time step is matched to one, and only one, state from the next time step. The model selection program 150 may also replace the state-permutation-invariant difference with a state-permutation-invariant difference between two sets of emission distributions estimated from time consecutive pairs of observable variables xₜ and xₜ₊₁, wherein the emission distributions are probability distributions of the observable variable given the corresponding latent variable

A state-permutation-invariant difference Δₜ is calculated for every pair of time steps through the current time step “T”:two-state model state-permutation-invariant differences {Δ₀, Δ₁, Δ₂, . . . Δ_{T-1}}. In another embodiment, a state-permutation-invariant difference Δₜ is calculated for the most recent M time steps, i.e., t=T−M, T−M+1, . . . , T−1, for some integer M, which a user specifies.

The model selection program 150 may then calculate a time inconsistency measure for the model (block 210). The time inconsistency measure may include summarizing the state-permutation-invariant differences. For example, the time inconsistency measure may include an average of the state-permutation-invariant differences for that state:

$$\frac{1}{T - 1} \sum \{ {Δ}_{0} \text{:} {Δ}_{T - 1} \} .$$

This gives a single value for how well the number of states represents the data stream.

The model selection program 150 repeats the procedures until a different number of states have been modeled (block 212). If every selected number of states have not been modeled (block 212, “No”), then the procedures are repeated. FIGS. 4A-4B illustrate the

FIGS. 4A-4B depict graphical representations of the operational procedures taken on the data stream of observable variables 302 by the model selection program 150, in accordance with an embodiment of the present invention. FIG. 4A represents operational procedures at the first time step “T”, while FIG. 4B represents operational procedures at the second time step “T+1” with the additional observable variable 320. FIGS. 4A and 4B have three states: state one 410, state two 412, and state three 414 at the first time step; and state one 422, state two 424, and state three 426 at the second time step. The observable variables 302, 320 are the same as described above vis a vis FIGS. 3A-3D, but with the additional states in FIGS. 4A-4B, however, the model selection program 150 will estimate different model parameters (second occurrence of block 204) and different latent variables (second occurrence of block 206).

The model selection program 150 will also calculate a state-permutation-invariant difference Δₜ for each time consecutive pair of latent variables (second occurrence of block 208). The model selection program 150 takes the latent variables included in the first state at the first time step (i.e., state one 410), and compares them to all states for the next succeeding time step (i.e., state one 422, state two 424, and state three 426). The model selection program 150 also takes the latent variables included in the second state at a first time step (i.e., state two 412), and compares them to all states for the next succeeding time step (i.e., state one 422, state two 424, and state three 426). The model selection program 150 also takes the latent variables included in the third state at a first time step (i.e., state two 414), and compares them to all states for the next succeeding time step (i.e., state one 422, state two 424, and state three 426). As was the case with the two-state model above, the comparison with the smallest difference for all states is kept by the model selection program 150 as the state-permutation-invariant difference Δₜ. In certain embodiments, the model selection program 150 may also enforce exclusivity so that each state from a first time step is matched to one, and only one, state from the next time step.

The model selection program 150 then calculates a state-permutation-invariant difference Δₜ again for every pair of time steps through the current time step “T”:two-state model state-permutation-invariant differences {Δ₀, Δ₁, Δ₂, . . . Δ_{T-1}}, and calculates a time inconsistency measure for the model as described above (second occurrence of block 210). differences. The time inconsistency measure for each number of states may be compared to select the best representation for the data stream. For example, a data stream may produce time inconsistency measures corresponding to a time inconsistency measure graph 500 depicted in FIG. 5. The graph 500 includes an abscissa 502 showing the number of states, and an ordinate showing the time inconsistency measure. For each number on the abscissa 502, the procedures taken by the model selection program 150 produce a time inconsistency measure 506 graphed on the graph 500. For the data stream of the embodiment shown in FIG. 5, the best model has three states, since that model corresponds to a lowest time inconsistency measure 508.

The procedures of the model selection program 150 shown in FIG. 2 may be repeated over time to account for the changing time inconsistency measures from additional observable variables. That is, additional observable variables may cause the graph to shift over time. In one non-limiting example, if one additional observable variable is added that does not fit into any of the currently-optimal states, one of the states may expand to encompass this new observable variable without increasing the time inconsistency measure in a significant way. If that more additional variables are added near the first additional variable, then the model may have a lower time consistency measure with an additional state. For the embodiment illustrated in FIG. 5, for example, this may mean that the 4 state model has a time inconsistency measure that decreases with each new time step, and the 3 state model has a time inconsistency measure the increases with each new time step, until the 4 state model has a lower time inconsistency model. When this condition occurs, the model selection program 150 may switch to modeling the data stream with a four-state model rather than a three-state model.

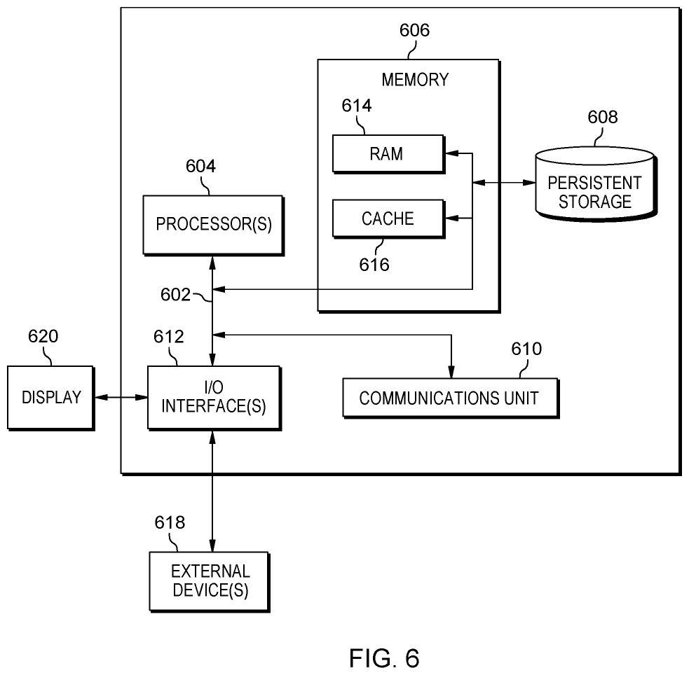

FIG. 6 depicts a block diagram of components of the server computer 120 in accordance with an illustrative embodiment of the present invention. It should be appreciated that FIG. 6 provides only an illustration of one implementation and does not imply any limitations with regard to the environments in which different embodiments may be implemented. Many modifications to the depicted environment may be made.

The server computer 120 includes communications fabric 602, which provides communications between RAM 614, cache 616, memory 606, persistent storage 608, communications unit 610, and input/output (I/O) interface(s) 612. Communications fabric 602 can be implemented with any architecture designed for passing data and/or control information between processors (such as microprocessors, communications and network processors, etc.), system memory, peripheral devices, and any other hardware components within a system. For example, communications fabric 602 can be implemented with one or more buses or a crossbar switch.

Memory 606 and persistent storage 608 are computer readable storage media. In this embodiment, memory 606 includes random access memory (RAM). In general, memory 606 can include any suitable volatile or non-volatile computer readable storage media. Cache 616 is a fast memory that enhances the performance of computer processor(s) 604 by holding recently accessed data, and data near accessed data, from memory 606.

The chart evaluator 102 may be stored in persistent storage 608 and in memory 606 for execution and/or access by one or more of the respective computer processors 604 via cache 616. In an embodiment, persistent storage 608 includes a magnetic hard disk drive. Alternatively, or in addition to a magnetic hard disk drive, persistent storage 608 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 608 may also be removable. For example, a removable hard drive may be used for persistent storage 608. Other examples include optical and magnetic disks, thumb drives, and smart cards that are inserted into a drive for transfer onto another computer readable storage medium that is also part of persistent storage 608.

Communications unit 610, in these examples, provides for communications with other data processing systems or devices. In these examples, communications unit 610 includes one or more network interface cards. Communications unit 610 may provide communications through the use of either or both physical and wireless communications links. The chart evaluator 102 may be downloaded to persistent storage 608 through communications unit 610.

I/O interface(s) 612 allows for input and output of data with other devices that may be connected to server computer 102. For example, I/O interface 612 may provide a connection to external devices 618 such as a keyboard, keypad, a touch screen, and/or some other suitable input device. External devices 618 can also include portable computer readable storage media such as, for example, thumb drives, portable optical or magnetic disks, and memory cards. Software and data used to practice embodiments of the present invention (e.g., the chart evaluator 102) can be stored on such portable computer readable storage media and can be loaded onto persistent storage 608 via I/O interface(s) 612. I/O interface(s) 612 also connect to a display 620.

Display 620 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

1. A computer-implemented method for selecting a model, the method comprising:
inputting a data stream comprising observable variables x_{1:t} into a first model comprising a first number of states, wherein each observable variable represents a value at a time step, and the data stream increases by one observable variable after a successive time step;
estimating a first model parameter of the first model using the observable variables x_{0:T};
estimating first latent variables z_{0:T}(x_{0:T}) that associate each observable variable with one of the first number of states;
calculating first state-permutation-invariant differences Δ_{0:T} between each time consecutive pair of latent variables, zₜ(xₜ) and zₜ₊₁(xₜ₊₁);
calculating a first time inconsistency measure for the first model by summarizing the first state-permutation-invariant differences Δ_{0:T};
inputting the data stream into a second model comprising a second number of states;
estimating a second model parameter of the second model using the observable variables x_{0:T};
estimating second latent variables z_{0:T}(x_{0:T}) that associates each observable variable with one of the second number of states;
calculating a second state-permutation-invariant difference Δ_{0:T} between each time consecutive pair of latent variables, zₜ(xₜ) and zₜ₊₁(xₜ₊₁);
calculating a second time inconsistency measure for the second model by summarizing the state-permutation-invariant differences Δ_{0:T};
determining a smallest time inconsistency measure between the first time inconsistency measure and the second time inconsistency measure; and
selecting one of the first model and the second model, based on the model corresponding to the smallest time inconsistency measure.

2. The method of claim 1, comprising repeating the procedures for K models comprising K number of states, wherein K comprises an integer selected from the group consisting of integers between 3 and 10.

3. The method of claim 1, wherein the first model comprises a selection from the group consisting of a Gaussian mixture model and a hidden Markov model.

4. The method of claim 1, wherein estimating the model parameter and the latent variable zₜ comprises using a selection from the group consisting of an MCMC sampler and a Bayesian method.

5. The method of claim 1, wherein estimating the first latent variables z_{0:T}(x_{0:T}) comprises a selection from the group consisting of: (i) a posterior distribution determined from the data stream and the estimated model parameter and (ii) a maximum-a-posteriori estimator determined from the data stream and the estimated model parameter.

6. The method of claim 1, comprising replacing the first state-permutation-invariant difference with a state-permutation-invariant difference between two sets of emission distributions estimated from time consecutive pairs of observable variables xₜ and xₜ₊₁, wherein the emission distributions are probability distributions of the observable variable given the corresponding latent variable.

7. The method of claim 1, wherein summarizing multiple state-permutation-invariant differences comprises the average of the multiple state-permutation-invariant differences.

8. A computer program product comprising:
one or more computer readable storage media, and program instructions collectively stored on the one or more computer readable storage media, the program instructions comprising instructions for:
inputting a data stream comprising observable variables x_{0:T} into a first model comprising a first number of states, wherein each observable variable represents a value at a time step, and the data stream increases by one observable variable after a successive time step;
estimating a first model parameter of the first model using the observable variables x_{0:T};
estimating first latent variables z_{0:T}(x_{0:T}) that associate each observable variable with one of the first number of states;
calculating first state-permutation-invariant differences Δₜ between each time consecutive pair of latent variables, zₜ(xₜ) and zₜ₊₁(xₜ₊₁);
calculating a first time inconsistency measure for the first model by summarizing the first state-permutation-invariant differences Δ_{0:T};
inputting the data stream into a second model comprising a second number of states;
estimating a second model parameter of the second model using the observable variables x_{0:T};
estimating second latent variables z_{0:T} (x_{0:T}) that associates each observable variable with one of the second number of states;
calculating a second state-permutation-invariant difference Δₜ between each time consecutive pair of latent variables, zₜ(xₜ) and zₜ₊₁(xₜ₊₁);
calculating a second time inconsistency measure for the second model by summarizing the state-permutation-invariant differences Δ_{0:T};
determining a smallest time inconsistency measure between the first time inconsistency measure and the second time inconsistency measure; and
selecting one of the first model and the second model, based on the model corresponding to the smallest time inconsistency measure.

9. The computer program product of claim 8, wherein the computer program instructions comprise instructions for repeating the procedures for K models comprising K number of states, wherein K comprises a number selected from the group consisting of integers between 3 and 10.

10. The computer program product of claim 8, wherein the first model comprises a selection from the group consisting of a Gaussian mixture model and a hidden Markov model.

11. The computer program product of claim 8, wherein estimating the model parameter and the latent variable z_{0:T} comprises using a selection from the group consisting of an MCMC sampler and a Bayesian method.

12. The computer program product of claim 8, wherein estimating the first latent variables z_{0:T}(x_{0:T}) comprises a selection from the group consisting of: (i) a posterior distribution determined from the data stream and the estimated model parameter and (ii) a maximum-a-posteriori estimator determined from the data stream and the estimated model parameter.

13. The computer program product of claim 8, comprising replacing the first state-permutation-invariant difference with a state-permutation-invariant difference between two sets of emission distributions estimated from time consecutive pairs of observable variables xₜ and xₜ₊₁, wherein the emission distributions are probability distributions of the observable variable given the corresponding latent variable.

14. The computer program product of claim 8, wherein summarizing multiple state-permutation-invariant differences comprises the average of the multiple state-permutation-invariant differences.

15. A computer system comprising:
one or more computer processors, one or more computer readable storage media, and program instructions collectively stored on the one or more computer readable storage media for execution by at least one of the one or more computer processors, the program instructions comprising instructions for:
inputting a data stream comprising observable variables x_{0:T} into a first model comprising a first number of states, wherein each observable variable represents a value at a time step, and the data stream increases by one observable variable after a successive time step;
estimating a first model parameter of the first model using the observable variables x_{1:t};
estimating first latent variables z_{0:T}(x_{0:T}) that associate each observable variable with one of the first number of states;
calculating first state-permutation-invariant differences Δ_{0:T} between each time consecutive pair of latent variables, zₜ(xₜ) and zₜ₊₁(xₜ₊₁);
calculating a first time inconsistency measure for the first model by summarizing the first state-permutation-invariant differences Δ_{0:T};
inputting the data stream into a second model comprising a second number of states;
estimating a second model parameter of the second model using the observable variables x_{0:T};
estimating second latent variables z_{0:T}(x_{0:T}) that associates each observable variable with one of the second number of states;
calculating a second state-permutation-invariant difference Δ_{0:T} between each time consecutive pair of latent variables, zₜ(xₜ) and zₜ₊₁(xₜ₊₁);
calculating a second time inconsistency measure for the second model by summarizing the state-permutation-invariant differences Δ_{0:T};
determining a smallest time inconsistency measure between the first time inconsistency measure and the second time inconsistency measure; and
selecting one of the first model and the second model, based on the model corresponding to the smallest time inconsistency measure.

16. The system of claim 15, wherein estimating the first latent variables z_{0:T}(x_{0:T}) comprises a selection from the group consisting of: (i) a posterior distribution determined from the data stream and the estimated model parameter and (ii) a maximum-a-posteriori estimator determined from the data stream and the estimated model parameter.

17. The system of claim 15, wherein the first model comprises a selection from the group consisting of a Gaussian mixture model and a hidden Markov model.

18. The system of claim 15, wherein estimating the model parameter and the latent variable comprises using a selection from the group consisting of an MCMC sampler and a Bayesian method.

19. The system of claim 15, wherein the computer program instructions comprise instructions for replacing the first state-permutation-invariant difference with a state-permutation-invariant difference between two sets of emission distributions estimated from time consecutive pairs of observable variables xₜ and xₜ₊₁, wherein the emission distributions are probability distributions of the observable variable given the corresponding latent variable.

20. The system of claim 15, wherein summarizing multiple state-permutation-invariant differences comprises the average of the multiple state-permutation-invariant differences.
